(19) United States
(12) Patent Application Publication
(10) Pub. No.: US 2003/0233265 A1
(43) Pub. Date: Dec. 18, 2003

(54) Method, system and program product for interactive electronic meeting scheduling

(75) Inventors: Raymond Lee, Boston, MA (US); Percy Liang, Cambridge, MA (US); Benjamin H. Szekely, Ithaca, NY (US); Christopher R. Vincent, Arlington, MA (US)

Correspondence Address: Floyd A. Gonzalez, IBM Corporation, 2455 South Road, P386, Poughkeepsie, NY, 12601, US

(73) Assignee: International Business Machines Corporation, Armonk, NY

(21) Appl. No.: 10/173,264

(22) Filed: Jun. 17, 2002

(51) Int. Cl. G06F 17/60

(52) U.S. Cl. 705/8; 708/112

(57) ABSTRACT

A system, method and program product for interactively scheduling and negotiating meetings wherein an active agent program accepts meeting criteria from a meeting requester and interacts with invitees to resolve availability according to the meeting criteria. The agent transmits the negotiated meeting schedule to invitees and optionally requires confirmation from invitees.

### BACKGROUND OF THE INVENTION

As the World Wide Web (the Web) has become useful in a wide variety of applications, it has found use in maintaining personal calendars on a variety of computers. These personal calendars are used to manage an individual's scheduling of events and activities as well as providing related useful function such as an alarm mechanism to alert the individual that he has something on his calendar that needs attention such as an eminent meeting, social engagement or spouses anniversary and the like.

Such calendars are applications or routines of applications that run on a computer such as a PDA, Laptop, Desktop PC, or an attached server for example.

FIG. 1 depicts the elements that make up a typical computer for use in presenting and maintaining a prior art calendar application. The computer 100 consists of a Base Computer 101 which comprises a processor 106, storage media such as a magnetic disk 107 and a high speed volatile main memory 105. An operating system and application programs 111 reside on the storage media 107 and are paged into main memory 105 as needed for computations performed by the processor 106. The Base computer may include optional peripheral devices including a video display 102, a printer or scanner 110, a keyboard 104, a pointing device (mouse) 103 and a connection 108 to a network 109. In a calendaring environment, a user will interact with a local calendar by use of a keyboard 104 and mouse 103 in conjunction with the display of calendar information on the display 102 under control of a calendar program 112. The calendar program will then interact with remote calendars by way of the network 109.

In FIG. 2 an example prior art Internet system is shown. A user at client 1 201 maintains a calendar on his system. This user's calendar system at client 1 201 can interact with clients 2-4 202-204 by way of a client server computer 206. Calendaring applications 112 may be provided by each client 201-205 and/or the client server 206 or some remote server 208 by way of the network 207. The user's calendar system at client 1 201 can interact with a remote calendar system at client 5 205 by way of the Internet network 207.

Calendar applications are often part of Web-enabled collaboration applications such as the LOTUS NOTES application available from International Business Machines. The Web provides a platform to permit many computers to view and share calendars. This provides many useful opportunities. With a Web based calendar system, a first user can permit a second user to see the first user's calendar. This is advantageous, for instance, in a business application where a manager may need to know the availability of his employees, a group of employees may need to coordinate with each other or a person may need to contact another person but needs to know when he is available (not on vacation, traveling, in a meeting etc.)

Scheduling a common time for members of a team to get together is a significant use of the calendering system. Individuals can make their calendar readable to a scheduling system but not allow individuals to actually see the calendar. Thus, a scheduling application can provide a user with a depiction of what times are available for an individual. Applications such as LOTUS NOTES provide means for an individual to list a plurality of other individuals and ask the application to find time slots that are available for all of the listed other individuals. The application then accesses the calendars of the other individuals to retrieve empty time slots. Finally the application combines the time slots available for each of the other individuals in combination for display to the individual requesting the meeting.

U.S. Pat. No. 5,050,077 (Vincent) assigned to the present assignee and incorporated herein by reference teaches a method for scheduling meetings. In this patent, a prompting screen is presented to a meeting scheduler with blanks for keying in desired times, dates, and prospective invitees for a meeting. In response to the schedulers keying to this screen, a comparison is made with the calendar of events for each prospective invitee. As a result of the non-availability of a meeting time which complies with the desired times, dates and invitees, certain of these factors are automatically altered or “relaxed” in order to achieve an acceptable meeting time. An option list of meeting times is then presented to the scheduler for selection of a meeting time. Based upon the selection of the scheduler, a meeting notification screen is then constructed for transmittal to each invitee.

The Vincent patent example of prior art as is typical, doesn't facilitate a invitee to interact with the scheduler. The scheduling is performed based on the attendee's calendar information.

### SUMMARY OF THE INVENTION

The present invention teaches a calendaring system wherein a meeting requester interacts with online invitees and calendars of off-line invitees.

The meeting scheduler is presented a GUI interface to the calendaring system. The scheduler provides various criteria for the meeting including an invitee list and attributes of the invitee such as whether he is required for the meeting or a quorum of a minimum number of invitees to successfully schedule the meeting. The scheduler also provides criteria such as a date or date range, a time or time range and the like for the meeting to be scheduled in.

The calendaring system then negotiates a schedule with invitees who are online interactively. This may be done real time by instant messaging techniques or it may be done in background by e-mail communication. The calendaring system has access to invitee calendars and by using a deadline algorithm, will opt for the invitee calendar when an interactive response is not forthcoming.

In a preferred environment, invitees are contacted by an active agent via instant messaging requesting free time and optional information such as preferences. The invitee responds to the active agent which accumulates responses from invitees. The active agent will query calendars for invitees and use the calendar information when an invitee doesn't respond in a predetermined time. The active agent, after accumulating first pass meeting information, may optionally send a second instant message to invitees requesting availability preferences when there are conflicts with availability. Finally, the active agent sends meeting notices to invitees requesting confirmation.

It is an object of the present invention to provide a meeting scheduler application that negotiates scheduling a meeting interactively with online invitees.

It is a further object of the invention to augment interactive scheduling with invitee calendar information when an invitee is not responsive to interactive negotiation.

It is yet another object of the present invention to send meeting notices to invitees when the interactive negotiation is successful.

It is another object of the present invention to provide GUI facilities for the scheduler to interact with the meeting scheduler application to provide meeting criteria for the interactive meeting scheduler to use to schedule meetings.

These and other objects will be apparent to one skilled in the art from the following detailed description of the invention taken in conjunction with the accompanying drawings in which:

### BRIEF DESCRIPTION OF THE DRAWINGS:

FIG. 1 is a diagram depicting an example prior art computer system;

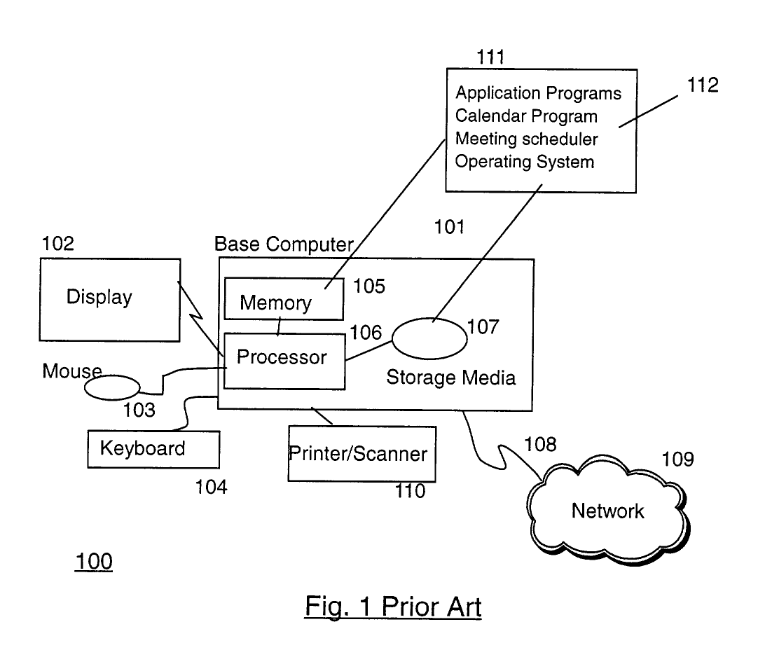

FIG. 2 is a diagram depicting a prior art network interconnecting computer systems;

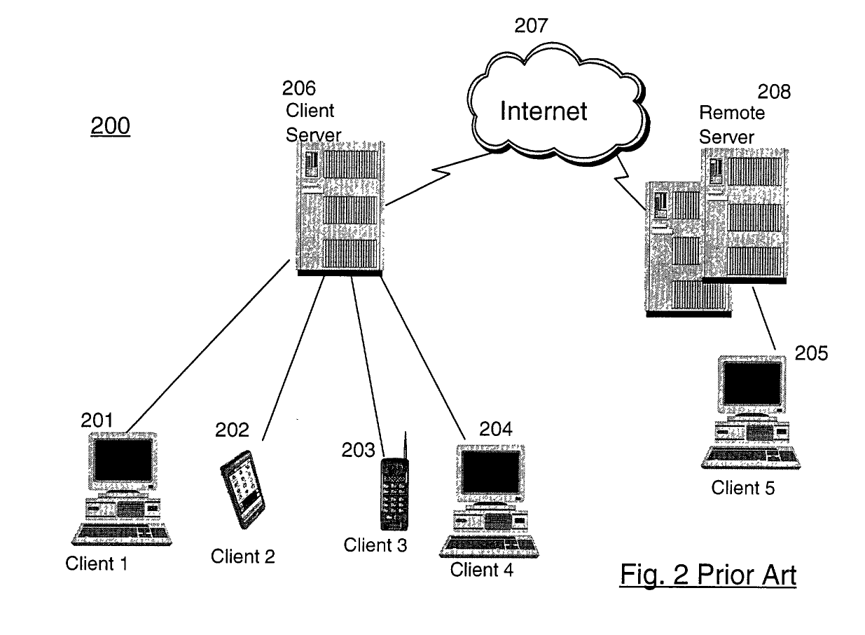

FIG. 3 depicts an example input display for requesting a meeting;

FIG. 4 depicts another view of the input display for requesting a meeting;

FIG. 5 depicts a mail and calendar display for alerting an invitee of a meeting request;

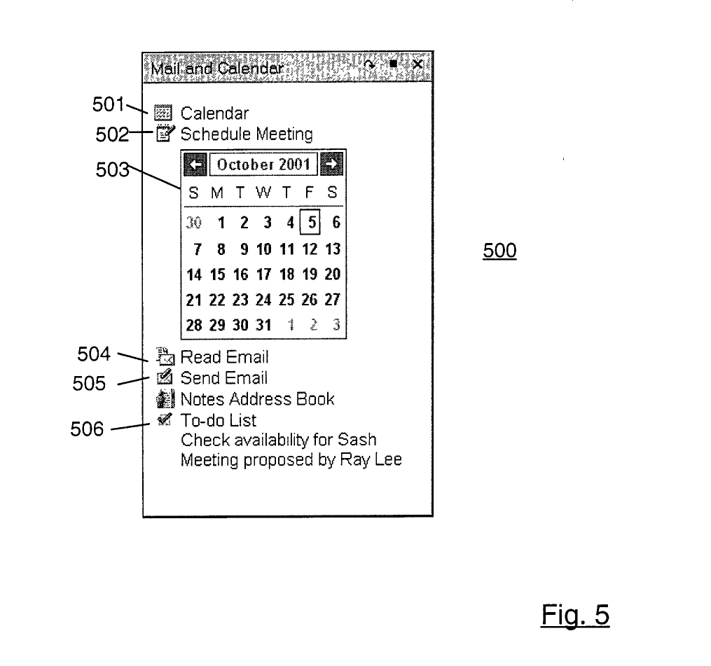

FIG. 6 is a view of a screen for entering an invitee's availability for a meeting to be scheduled;

FIG. 7 is a view of a mail and calendar display for alerting an invitee of a meeting schedule requiring confirmation;

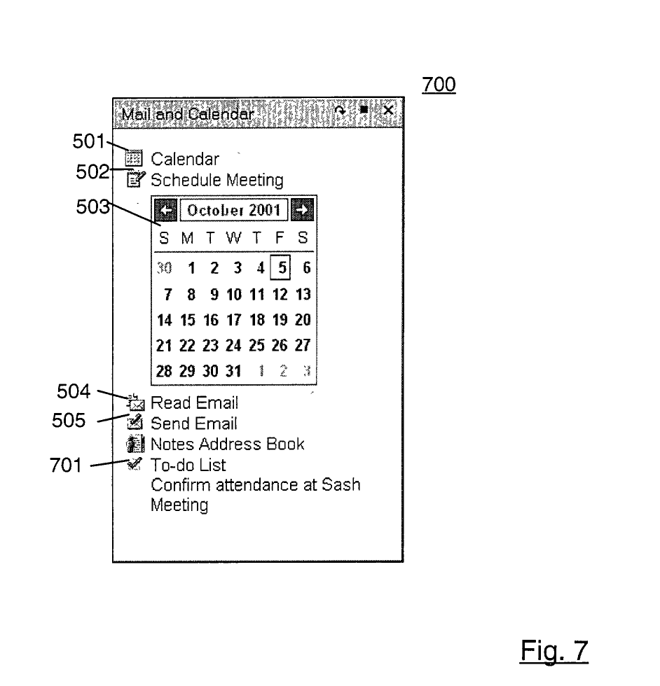

FIG. 8 is a high level flow of an embodiment of the present invention;

FIG. 9 is a flow of interactively creating the meeting criteria;

FIG. 10 is a flow of interactively negotiating a meeting schedule;

FIG. 11 is a flow of notifying invitees of a scheduled meeting; and

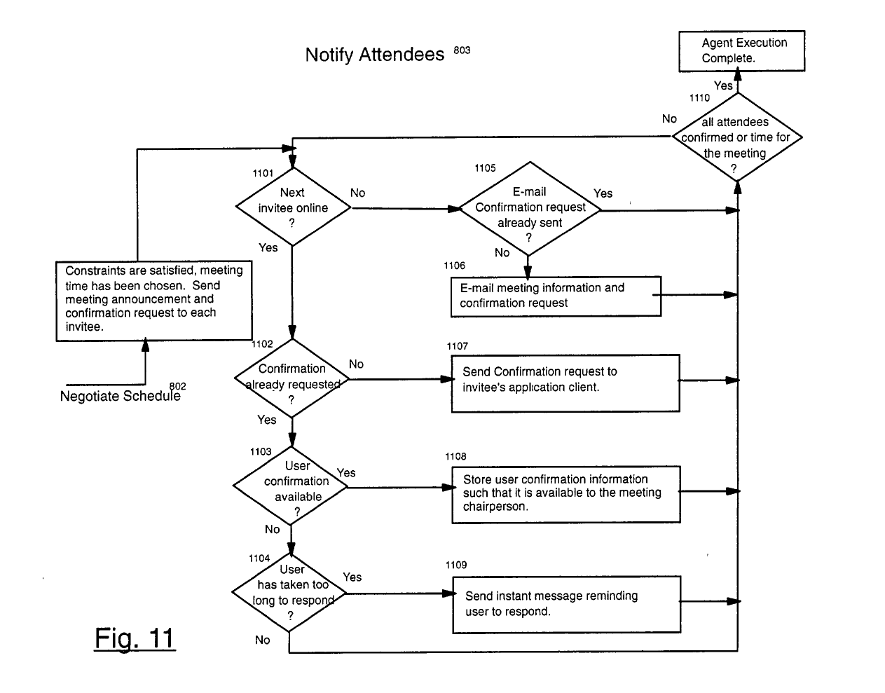

FIG. 12 depicts the method of providing multiple modes for interacting with invitee.

### DESCRIPTION OF THE PREFERRED EMBODIMENT

The present invention provides a method for interactively scheduling meetings. A program that acts as a human (active agent) interacts with invitees on behalf of a meeting requester.

In a preferred embodiment, users are attached to the World Wide Web (the Web). A program for scheduling meetings is a web service and comprises a program running on a server on behalf of clients (users). The users may have conventional calendars on their system such as the LOTUS NOTES calendar from IBM. When a user wants to schedule a meeting (meeting requester), he accesses the scheduling program and is presented a GUI display for entering meeting criteria. The practice of the present invention is not limited to the Web. A peer to peer environment or groups of peers (grid) would provide interactive meeting scheduling using the present invention except that the active agent performing the scheduling function would be provided by a peer computer rather than a client server.

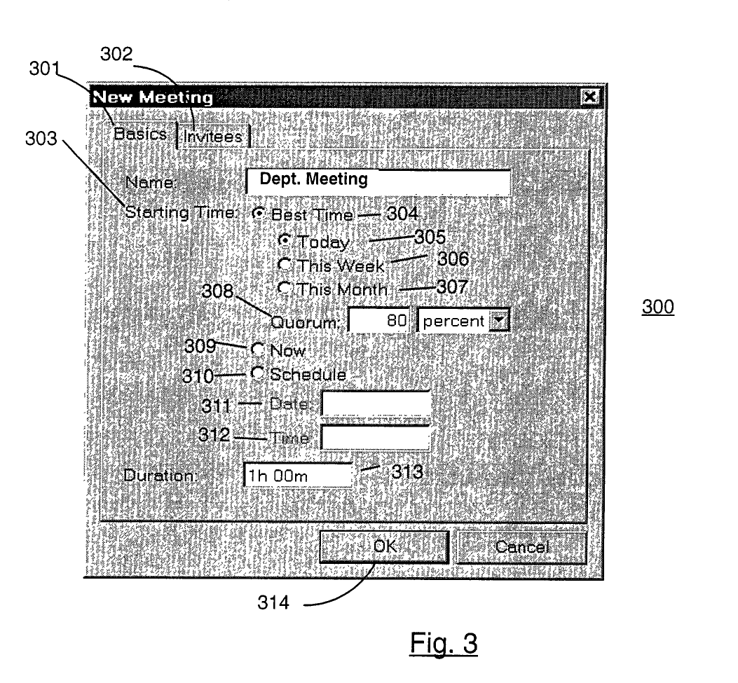

FIG. 3 shows an example screen for scheduling a meeting with two selectable tabs i.e. Basics 301 and Invitees 302.

The Basics tab 301 when selected displays fields for setting up meeting criteria. In the example, a name of the meeting (Dept. Meeting) is entered by the meeting requester. As used herein, the meeting requester is the person requesting the meeting. In another preferred embodiment, a description of the purpose of the meeting (not shown) and other information to be provided to the invitees can be entered into the screen in addition to the name of the meeting.

The proposed time frame (starting time 303) of the meeting is provided. In the example, a best time 304 criteria is selected. This option allows the time frame to be today 305, this week 306 or this month 307. In the example, today 305 is selected. Other options include starting time now 309 indicating the meeting is immediate, and schedule 310. Schedule 310 option allows the requester to provide a specific time and/or date for the meeting.

The required duration 313 of the meeting is entered by the requester. This is the amount of time to be reserved for the meeting. Other such information might be a time range for the meeting or a duration for invitee such that each invitee can be scheduled for a predefined period or duration of the meeting.

A quorum criteria 308 provides a mechanism for the requester to indicate the number of people who must be available for the meeting to be scheduled. In the example, a percent is selected of 80%. Other quorum mechanisms could be selected such as a number of people. In one embodiment, the quorum mechanism provides for types of invitees such as selecting any 2 of a “must attend” group, 50% of general invitee list and the like.

Once the required Basics 310 information is entered, and the user is satisfied with the information, he can select the invitees tab 302. If he enters O.K. 314 without identifying invitees, he will be prompted to go to the invitee selection screen.

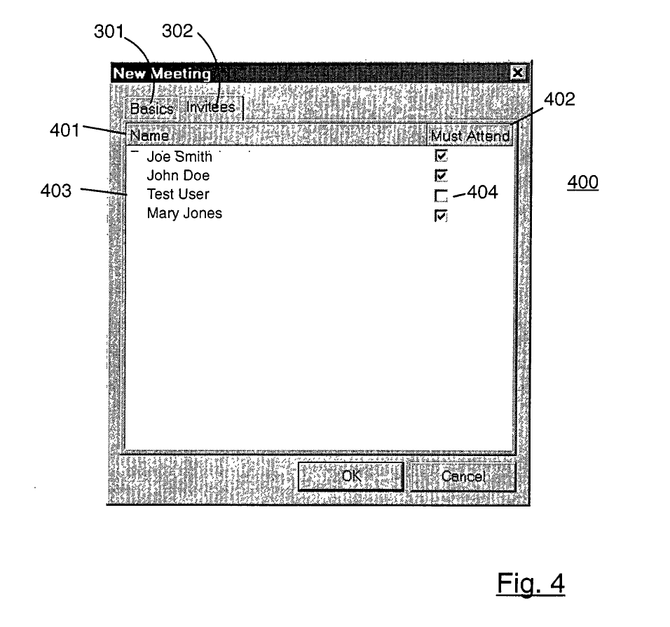

FIG. 4 depicts an example invitees display of a preferred embodiment. This display permits the user to list attendees (invitees) by name (404) and attendance criteria such as must attend 402 indication. In the example, all named invitees except the invitee named “Test User” 403 are required for the meeting, thus the must attend field is selected for all but the Test User's must attend field 404.

In other embodiments, invitee methods are used such as selecting invitees from a master list, entering the invitee Web address instead of their name, entering a group name which indirectly provides a list of names and the like.

In another embodiment, another invitee criteria is a FYI (for your information) indicator. The FYI indicator indicates to the scheduler application to send to the invitee a notice of the final meeting but not to negotiate schedule with the invitee.

In one embodiment, each invitee has an indicator indicating whether he can attend by Phone, Instant message, Video conference or in person.

Once the Basics 301 and invitees 302 fields are completed, the user hits the O.K. Button 314 which submits the request to the scheduler agent.

The scheduling agent sends an alert message 506 to the invitees. The alert preferably sets an indicator on the user's calendering application 500, alerting him that he has a “to-do List” entry 506 and graphically indicates to the user information about the meeting request such as the meeting requester's name and the title of the meeting 506. In another embodiment, the interaction is by way of Instant Messages between the Scheduler Agent and the invitee. In another embodiment, the interaction is by way of e-mail messages. In another embodiment, the interaction is by way of a client application for scheduling meetings.

The agent monitors the invitees that are not online and sends the alert notification 506 when they become available. In a preferred embodiment, the agent has access to invitee calendar systems and can elect to use the calendar for those applications that aren't responsive in a predetermined amount of time. The use of calendar information to augment interactive negotiation is in one embodiment selected by the meeting requester, in another is part of the meeting negotiation algorithm in the agent program and in another embodiment is preselected by an invitee.

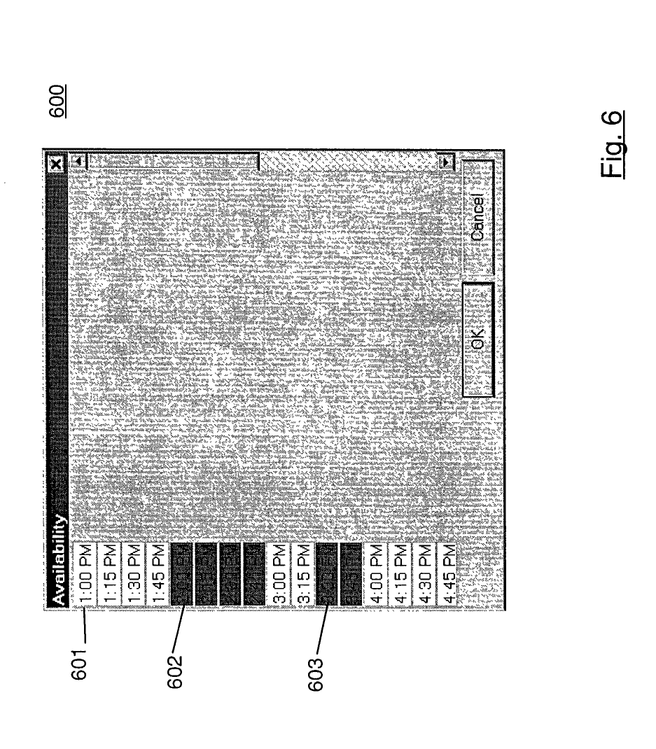

In the preferred embodiment, the invitee is presented a display 600 which he must respond to. The display may be a graphical depiction of time which the user can use to indicate his availability. In FIG. 6, the invitee has selected 2:00 PM to 3:00 PM 602 and 3:30 PM to 4:00 PM 603 as available times. In another embodiment, the user can indicate levels of preference for the free time, 10 being totally available and 1 being possibly available. In yet another embodiment, the invitee includes a message to the meeting scheduler such as “I may be taking vacation that day”.

When the response is ready, the invitee clicks the O.K. Button which sends the response to the scheduling agent.

The scheduling agent waits a predetermined amount of time for responses. At that time, if the critical invitees have responded (critical invitees is determined by the meeting requester criteria of quorum or other indicators), the scheduler agent sends the meeting notice 701 to the invitees and requester. In another embodiment, the agent sends the meeting notice to the requester 701 for approval before sending the notice to invitees.

In a preferred embodiment, the request sent to the invitees requires confirmation 701. The confirmation is returned to the scheduling agent. The scheduling agent presents the invitee list to the meeting scheduler indicating confirmation status as well as invitee status where the invitee status includes that he will not attend or that he may attend indicators.

In one embodiment, the meeting is added to the attendee's calendar only when he confirms his attendance, in another embodiment, the invitee can elect to add the meeting notice to the calendar, in another embodiment, the meeting notice is added to the calendar independent of the attendee's confirmation.

In the preferred embodiment, the scheduler agent provides the meeting requester with progress status of the negotiations with invitees while the negotiations are in progress. In one embodiment, the meeting requester can interact with the meeting negotiations by modifying the meeting criteria screen, i.e. add or delete invitees, change date/time of suggested meeting etc.

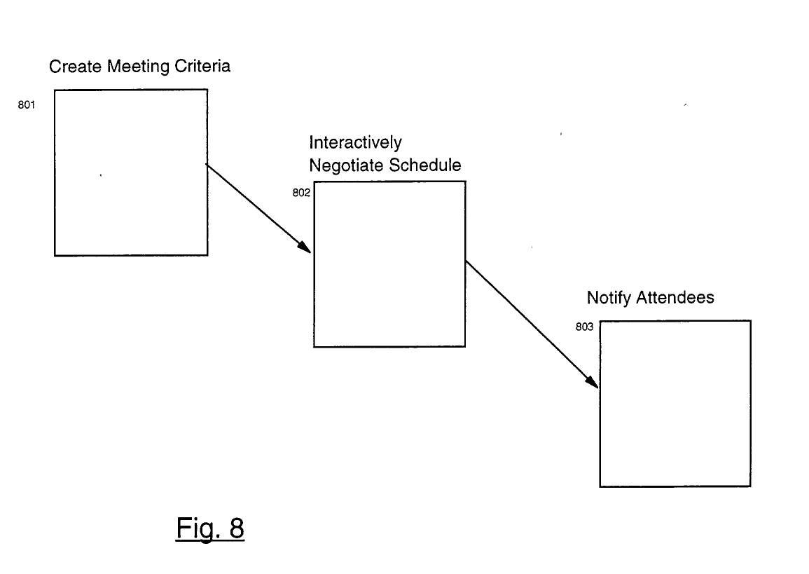

FIG. 8 depicts the high level flow of the present invention. A meeting requester interacts with the scheduler agent and creates the criteria 801 for the proposed meeting. The scheduling agent preferably operating at a client server, negotiates a schedule 802 with invitees interactively using criteria supplied by the meeting requester. The scheduling agent notifies invitees 803 of the negotiated meeting.

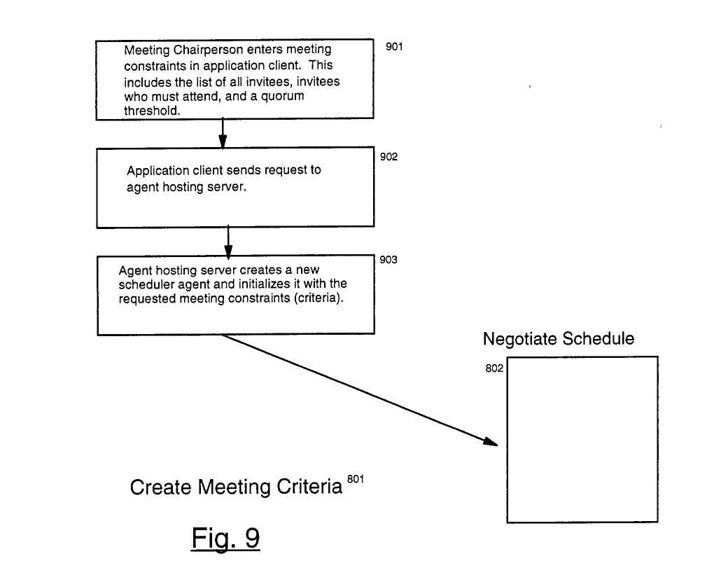

A preferred embodiment of the meeting criteria step 801 is depicted in FIG. 9. The Meeting Chairperson (requester) enters meeting constraints 901 in an application client. This includes the list of invitees, quorum threshold, required invitees of the examples in FIGS. 3 and 4. The application client might be part of a calendering application, an instant messaging application or a separate application all together for example. The application client sends the request to an agent hosting server 902. The agent hosting server 902 receives the information identifying the meeting invitees and the meeting criteria from the meeting requester. The agent hosting server creates a new scheduler agent and initializes it with the requested meeting constraints (criteria) 903.

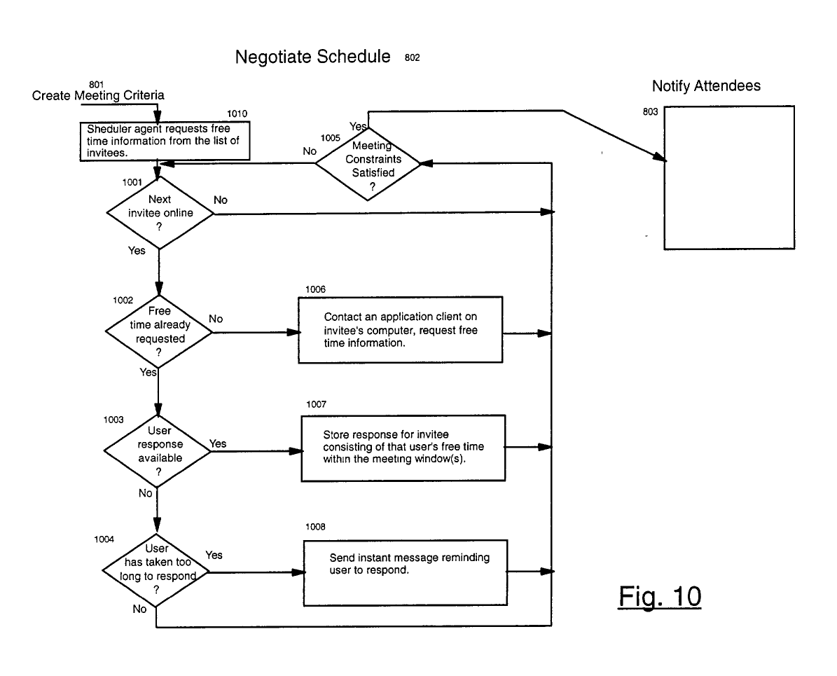

A preferred embodiment of the negotiation of the meeting schedule is depicted in FIG. 10. The scheduler agent initiates the negotiation 801 by requesting free time information from each invitee on the list 1010 using a query generator. The agent tests if an invitee is on line 1001, if it is not, it returns that indication to a meeting constraints monitor 1005. The monitor 1005 will cause the agent to continue to attempt to negotiate with the invitee until the meeting constraints are satisfied. If a predefined time limit is surpassed, the monitor 1005 will take program dependent action such as inform the meeting requester that the meeting cannot be scheduled because of the meeting constraints, or the meeting is scheduled with the meeting constraints not being met.

When the agent detects the invitee is online 1001, the scheduler agent determines if it has requested free time of the invitee previously 1002, if not, the agent contacts an application client on the invitee's computer to request free time information 1006. In the preferred embodiment, the invitee is presented an information screen 500 including a to-do list 506 indicator. The indicator in one embodiment includes information about the meeting.

The invitee in one embodiment clicks with a mouse controlled cursor on the to-do list icon 506 and is presented with a screen requesting information about the invitee's availability 600. When the invitee has completed the information, the application client on the invitee's computer returns the information to the scheduler agent's meeting constraints monitor 1005.

If the free time has already been requested for the invitee 1002, a test is performed to see if the user response is available 1003. If it is 1007, the response information is stored and an indication that it has been received is provided to the monitor 1005. The response information includes indications of the invitee's free time.

If the invitee hasn't responded 1003, the agent tests to see if the response is overdue 1004. If the response is overdue, the agent sends an instant message (alternatively an e-mail) reminding the user to respond 1006. A second time threshold is used by the monitor 1005 to determine that the meeting scheduler can no longer wait for the response from invitees. In this case, the scheduler must according to meeting criteria, either schedule the meeting based on the responses received or notify the meeting requester that the meeting can not be scheduled and optionally provide the current statistics of the negotiation.

When the meeting constraints are satisfied 1005, the agent proceeds to notify invitees step 803. A determining mechanism in the scheduler agent determines a meeting schedule based on invitee availability and a notification generator in the scheduler agent notifies the invitee of the meeting schedule. The agent tests if the invitee is online 1101. If not, an e-mail is sent to the invitee requesting confirmation of attendance 1106 unless an e-mail has already been sent 1105. If the invitee is online 1101, a confirmation request is sent to him 1107 unless a confirmation has already been requested 1102.

If the invitee has responded to a confirmation request 1103, the confirmation information is stored 1108 so it can be provided to the meeting requester. If the user doesn't respond within a predetermined time 1104, a reminder is sent to him requesting him to respond 1109. When a time criteria for confirming the meeting attendance has expired the agent execution terminates. This time is the meeting schedule time in one embodiment or a predetermined earlier time specified by the user in another embodiment. In another embodiment, when the quorum of invitees has responded, the agent execution terminates.

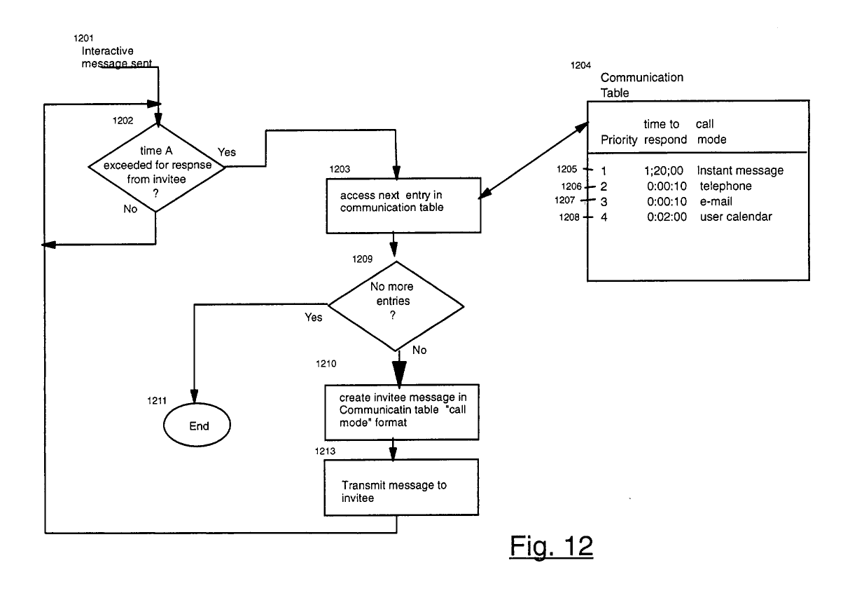

FIG. 12 depicts an example mechanism for selecting alternative modes of communication with the invitee. The agent waits a predetermined amount of time for a response from the invitee to an interactive message sent to the invitee 1201. When the time “A” is exceeded 1202, the agent accesses a communication table to determine if another mode of communication has been provided 1203. In the example Communication table 1204, there are 3 fields. A priority, time to respond, and call mode field. In the example 1204, the highest priority message 1205 is so indicated by a “1”, for this entry, a time to respond is selected of 1 day 20 hours and 00 minutes and becomes time “A”, after which an instant message is sent to the invitee. If no response is received when that time (“A”) elapses 1202, the next entry 1206 provides for creating an automated telephone message 1210 to be sent to the invitee 1213. Other mechanisms could be employed such as permitting multiple mode messages to be sent concurrently. Such methods would be obvious to one skilled in the art in practicing the present invention.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method using an agent program for interactively negotiating with an online meeting invitee and scheduling a meeting, said method comprising the steps of:
receiving information from a meeting requester, said information identifying said meeting invitee and meeting criteria;
querying said invitee for invitee availability information according to said meeting criteria; and
determining a resultant meeting schedule based on said invitee availability information according to said meeting criteria; and
notifying said invitee and said meeting requester of said resultant meeting schedule.

2. The method according to claim 1 comprising the further step of providing a graphical user interface to said meeting requester, said graphical user interface prompting said meeting requester for said information identifying a meeting invitee and meeting criteria.

3. The method according to claim 1 comprising the further step of providing a graphical user interface to said meeting requester said graphical user interface indicating progress of said determining step.

4. The method according to claim 1 wherein said information identifying a meeting invitee includes any one of invitee name, invitee e-mail name, invitee identifier, invitee group name, invitee phone number or invitee nickname.

5. The method according to claim 1 wherein said information identifying meeting criteria includes any one of meeting date, meeting time, quorum of invitees required to have the meeting, invitee must attend indicator, meeting date range, meeting time range, title of meeting, meeting requester comment, duration of meeting or invitee mode of attendance.

6. The method according to claim 5 wherein an invitee mode of attendance includes any one of physical location, telephone, video conferencing or instant messaging.

7. The method according to claim 1 wherein said querying the invitee includes querying by use of any one of instant message, graphical user interface application, calendaring application, e-mail message or telephone automated messaging.

8. The method according to claim 1 wherein said invitee availability information includes any one of available time indication, available time preference indication, available in person indication, available by phone indication, available by video conference indication, available by instant message indication, available by e-mail indication or invitee representative available indication.

9. The method according to claim 1 wherein said invitee is notified of said resultant meeting schedule by any one of instant message, e-mail, automated telephone message, video message, graphical user interface application or calendaring application.

10. The method according to claim 1 wherein determining said resultant meeting schedule comprises the further step of determining a preferred meeting time using invitee availability information of said invitee in combination with availability information of a second invitee.

11. The method according to claim 1 comprising the further step of using availability information from an invitee on-line calendaring system when said invitee is not responsive within a predetermined amount of time.

12. A system using an agent program for interactively negotiating with an online meeting invitee and scheduling a meeting, said system comprising:
a receiver receiving information identifying said meeting invitee and meeting criteria from a meeting requester;
a query generator querying said invitee for invitee availability information according to said meeting criteria; and
a determining mechanism determining a resultant meeting schedule based on said invitee availability information according to said meeting criteria; and
a notify generator notifying said invitee and said meeting requester of said resultant meeting schedule.

13. The system according to claim 12 further a utility providing a graphical user interface to said meeting requester, said graphical user interface prompting said meeting requester for said information identifying a meeting invitee and meeting criteria.

14. The system according to claim 12 further comprising a second utility for providing a graphical user interface to said meeting requester said graphical user interface indicating progress of said determining step.

15. The system according to claim 12 wherein said information identifying a meeting invitee includes any one of invitee name, invitee e-mail name, invitee identifier, invitee group name, invitee phone number or invitee nickname.

16. The system according to claim 12 wherein said information identifying meeting criteria includes any one of meeting date, meeting time, quorum of invitees required to have the meeting, invitee must attend indicator, meeting date range, meeting time range, title of meeting, meeting requester comment, duration of meeting or invitee mode of attendance.

17. The system according to claim 16 wherein the invitee mode of attendance includes any one of physical location, telephone, video conferencing or instant messaging.

18. The system according to claim 12 wherein said query generator further queries use of any one of instant message, graphical user interface application, calendaring application, e-mail message or telephone automated messaging.

19. The system according to claim 12 wherein said invitee availability information includes any one of available time indication, available time preference indication, available in person indication, available by phone indication, available by video conference indication, available by instant message indication, available by e-mail indication or invitee representative available indication.

20. The system according to claim 12 wherein said invitee is notified of said resultant meeting schedule by any one of instant message, e-mail, automated telephone message, video message, graphical user interface application or calendaring application.

21. The system according to claim 12 wherein said determining mechanism comprises the further step of determining a preferred meeting time using invitee availability information of said invitee in combination with availability information of a second invitee.

22. The system according to claim 12 further comprising an apparatus for using availability information from an invitee on-line calendaring system when said invitee is not responsive within a predetermined amount of time.

23. A computer program product using an agent program for interactively negotiating with an online meeting invitee and scheduling a meeting, said computer program product comprising a computer readable medium having computer readable program code therein comprising the:
computer readable program code for receiving information identifying said meeting invitee and meeting criteria from a meeting requester;
computer readable program code for querying said invitee for invitee availability information according to said meeting criteria; and
computer readable program code for determining a resultant meeting schedule based on said invitee availability information according, to said meeting criteria; and
computer readable program code for notifying said invitee and said meeting requester of said resultant meeting schedule.

24. The computer program product according to claim 23 further comprising computer readable program code for providing a graphical user interface to said meeting requester, said graphical user interface prompting said meeting requester for said information identifying a meeting invitee and meeting criteria.

25. The computer program product according to claim 23 further comprising computer readable program code for providing a graphical user interface to said meeting requester said graphical user interface indicating progress of said determining step.

26. The computer program product according to claim 23 wherein said information identifying a meeting invitee includes any one of invitee name, invitee e-mail name, invitee identifier, invitee group name, invitee phone number or invitee nickname.

27. The computer program product according to claim 23 wherein said information identifying meeting criteria includes any one of meeting date, meeting time, quorum of invitees required to have the meeting, invitee must attend indicator, meeting date range, meeting time range, title of meeting, meeting requester comment, duration of meeting or invitee mode of attendance.

28. The computer program product according to claim 27 wherein the invitee mode of attendance includes any one of physical location, telephone, video conferencing or instant messaging.

29. The computer program product according to claim 23 wherein said querying the invitee includes querying by use of any one of instant message, graphical user interface application, calendaring application, e-mail message or telephone automated messaging.

30. The computer program product according to claim 23 wherein said invitee availability information includes any one of available time indication, available time preference indication, available in person indication, available by phone indication, available by video conference indication, available by instant message indication, available by e-mail indication or invitee representative available indication.

31. The computer program product according to claim 23 wherein said invitee is notified of said resultant meeting schedule by any one of instant message, e-mail, automated telephone message, video message, graphical user interface application or calendaring application.

32. The computer program product according to claim 23 wherein determining said resultant meeting schedule further comprises computer readable program code for determining a preferred meeting time using invitee availability information of said invitee in combination with availability information of a second invitee.

33. The computer program product according to claim 23 further comprising computer readable program code for using availability information from an invitee on-line calendaring system when said invitee is not responsive within a predetermined amount of time.
